(19) United States
(12) Patent Application Publication
(10) Pub. No.: US 2019/0147021 A1
(43) Pub. Date: May 16, 2019

(54) MULTIPLEXING, ISOLATING AND COLLABORATIVE MANAGEMENT INFORMATION SYSTEM AND METHOD

(71) Applicant: HEFEI HANTENG INFORMATION TECHNOLOGY CO., LTD., Hefei (CN)

(72) Inventor: Yegan QIAN, Hefei (CN)

(21) Appl. No.: 16/236,425

(22) Filed: Jan. 24, 2019

Related U.S. Application Data
(63) Continuation of application No. PCT/CN2017/111467, filed on Nov. 16, 2017.

(30) Foreign Application Priority Data
Nov. 27, 2016 (CN) 201611057764.X

(51) Int. Cl. G06F 17/22; G06Q 10/06; G06F 3/0484

(52) U.S. Cl. CPC G06F 17/2247; G06F 3/0484; G06Q 10/063

(57) ABSTRACT

A multiplexing, isolated and collaborative management information system and method. The system includes: managing organization tree; adding, modifying or deleting group company department information, affiliated company information and affiliated company department information; dynamically adding, modifying or deleting the employed company or organization information and its department information in the user information, and dynamically adding, modifying or deleting the connection company information in the user information; loading the logo and style of the employed company or organization based on the user's employed company information; in each business subsystem, for each web page that has data adding or deleting operation command or other pages with collaboration requirements, adding a drop-down selection control for the employed company and connection companies to the page and populating it with the employed company information and connection company information.

### CROSS-REFERENCE TO RELATED APPLICATIONS

This application is a continuation of International Patent Application No. PCT/CN2017/111467, filed on Nov. 16, 2017, which claims the benefit of priority from Chinese Application No. 201611057764.X, filed on Nov. 27, 2016. The entire contents of the aforementioned applications, including any intervening amendments thereto, are incorporated herein by reference.

### TECHNICAL FIELD

The invention relates to the field of management information system, in particular to a multiplexing, isolated, collaborative management information system.

### BACKGROUND OF THE INVENTION

With continuous development of information technology, many enterprises have built enterprise management information systems suitable for their own needs. These management information systems improve the management environment of enterprises, reduce the cost of enterprise management, and improve the efficiency of work.

In the continuous development and growth of enterprises, a limited company may develop into a group company having a number of limited companies, or a group company has already owned a number of limited companies. It is a forward-looking information planning problem for many enterprises to build a management information system which has full coverage between the group company and a number of limited companies under the group and is unified, isolated, collaborative and capable of elimination of the information island, and which realizes single sign-on. It is difficult for the current enterprise management information system to meet the above objects at the same time. After the implementation of a management information system in an enterprise, with the further development of the enterprise, one or more business-independent limited companies are derived from the enterprise, the operation management among the business-independent affiliated companies and the enterprise is still completely isolated, independent, and at the same time collaborated with each other, and realized single sign-on for users from different companies. Such adaptive management information system, which can dynamically meet the growth needs of enterprises, provides an effective solution to the forward-looking information planning problems mentioned above.

### SUMMARY OF THE INVENTION

The invention provides a multiplexing, isolated and collaborative management information system and method in order to solve the above problem. It solves the forward-looking information planning problem of the enterprise management information system. It can dynamically adapt to the development of enterprise and dynamically cover its later established affiliated companies, so that operation and management between the enterprise and each affiliated companies can be completely isolated from each other and yet independent and collaborative with each other, and capable of single sign-on for users from different companies.

To achieve the above objects, the invention provides a multiplexing, isolated and collaborative management information system, the system includes: At least one or more non-volatile memories and at least one or more processors, wherein the processor processing steps are as follows:

1) managing organization tree in the management information system, and dynamically adding, modifying or deleting group company department information, information on the affiliated company of the group company and affiliated company department information;

2) dynamically adding, modifying or deleting the characteristic information of the employed company, organization or department information of the employed company or organization in the user information of the group company or the affiliated companies ander the group company; dynamically adding, modifying or deleting the characteristic information of the connection company or organization in which the user has duties to perform;

3) dynamically loading the logo and Cascading Style Sheets of the employed company or organization based on the employed company or organization information of a user; and

4) in each business subsystem, for each of the web pages that have data adding or deleting operation command or other pages with collaboration requirements, adding a drop-down selection control or single-choice box control to the page and populating it with the characteristic information of both the employed company or organization and other connection companies, the data and resources loaded by the web page all come from the company or organization selected in the drop-down selection control or the single-choice box control.

The invention also provides a computer implemented method for multiplexing, isolating and collaborating of the management information system and the method is as follows.

Dynamical management of the organization tree: adding an organization management tree in the enterprise management information system, wherein the group company is the root node; dynamically adding, modifying or deleting child node, including dynamically adding, modifying or deleting group company department information; dynamically adding, modifying or deleting the information on the affiliated companies of the group company and affiliated company department information, and storing the group company characteristic information, the group company department characteristic information, the affiliated company characteristic information and the affiliated company department characteristic information in a database, as shown in FIG. 1.

Management of the user information: the field data features of the user information are shown in FIG. 3. The system administrator of the group company and the system administrator of each subsidiary company perform adding, modifying or deleting to the user information of the group company or the respective affiliated company under the group company. The user information includes the employed company or organization characteristic information and department information of the employed company or organization. The characteristic information of the employed company, organization or department information of the employed company, or organization in the user information may be dynamically added, modified or deleted. The user information further includes the characteristic information of connection companies or organizations in which the user has duties to perform, and characteristic information of the connection company or organization in the user information may also be dynamically added, modified or deleted. The user information is temporarily stored in a random access memory (RAM) in a Central Processing Unit of an application server in the form of a table shown in FIG. 4, or persisted in a storage of a database server.

Multiplexing and isolating of the management information system: the users from different companies log in through the same system log-in page. Upon the log-in and according to the user's employed company information, the management information system loads the proprietary information of the user's employed company, such as the logo and CSS (Cascading Style Sheets) files of the group company or its subsidiaries, and achieves single sign-on. according to the user's role assigned by the system administrator, different users acquire corresponding permissions. The corresponding business subsystems are loaded. This system loading process is transparent to the users, and realizes multiplexing and isolating of the system. FIG. 5 shows both the log-in and the loading process of the management information system.

Collaboration of the management information system: in each business subsystem, for each web page that has data adding or deleting command or for all pages, adding a drop-down selection control or single-choice box control populated with both the information of the employed company or organization and the information of the connection companies or organizations in which the logged on user has duties to perform to the page. The added drop-down selection control or single-choice box control populated with information of both the employed company or organization and the connection companies or organizations is initially set invisible or hidden state. The system verities the information of connection companies or organizations of the logged on user. If the connection companies or organizations information is empty, the drop-down selection control will be invisible or hidden, otherwise the drop-down selection control is set to visible or non-hidden state and populated with information of both the employed company or organization and the connection companies or organizations in which the logged on user has duties to perform from the backend database.

In the respective business subsystem of the management information system, in each web page that has data adding, modifying or deleting operation command, if the drop-down selection control or single-choice box control populated with information of both the employed company or organization and the connection companies or organizations of which the logged on user has duties to do is invisible or hidden, all the data loaded by the web page comes from the employed company of the user, all the newly modified or added data belongs to the employed company of the user, and all the deleted data is removed from the employed company of the user; if the described drop-down selection control has been populated with information of the group company and its affiliated companies from the backend database, the default option in the drop-down selection control or single-choice box control is set to the employed company of the user, the data and resources loaded by the web page all come from the employed company of the logged on user, the newly modified or added data and resources belong to the employed company of the user, and all the deleted data and resources are removed from the employed company of the user. Once the user selects other options in the drop-down selection control or single-choice box control, the data and resources loaded by the web page all come from the company selected in the drop-down selection control or single-choice box control, the newly modified or added data and resources belong to the company selected in the drop-down selection control or single-choice box control, and all the deleted data and resources are removed from the company selected in the drop-down selection control or single-choice box control. FIG. 6 shows the collaboration of the management information system.

Dynamical management of the LOGO and HTML Cascading Style Sheets of an organization or company: according to the employed company or organization information of the logged on user, the logo and style of the employed company or organization are loaded dynamically.

The invention solves the problem of management planning needs of the dynamic and self-adaptive management information system required by the continuous growth of an enterprise. The informatization not only serves the current enterprise, but also adapts to the future development of the enterprise. Thus the enterprise can use an management information system to manage the enterprise itself and all its independent companies, instead of installing a management information system for each company one by one. It realizes the multiplexing of management information system, and reduced the cost of software license greatly. Also, users who are only employed by the enterprise or one of the companies but has no connection ith other companies, are restricted to access the data and resources within the enterprise or company by which they are employed. It realizes the isolation and independence of the management information system among different companies., users who have connection with other companies, are also able to access the data and resources of the connection companies according to the permissions obtained from the role based permission management. It realizes the collaboration of the management system among different companies. The single sign-on of the system between the enterprise and different companies is realized. The unification of the system data between the enterprise and different companies is realized. The information island is eliminated.

### BRIEF DESCRIPTION OF THE DRAWINGS

For better explanation of the technical solutions of the embodiments of the invention, the following is a brief description of the drawings needed to describe the embodiments. It is obvious that the drawings described below are only embodiments of the invention, ordinary technicians in the field can also obtain other drawings based on these drawings without any creative effort.

FIG. 1 is a schematic diagram of an organization tree according to an embodiment of the invention;

FIG. 2 is a flow chart of a method for multiplexing, isolating and collaborating of a management information system according to an embodiment of the invention;

FIG. 3 is a schematic diagram of the field structures of user information in the system according to an embodiment of the invention;

FIG. 4 is a schematic diagram of storage structures of user information;

FIG. 5 is a schematic diagram of system log-in and loading of the management information system;

FIG. 6 is a schematic diagram of the collaboration of the management information system;

FIG. 7 is a schematic diagram of a hardware implementation for an embodiment of the invention.

### DETAILED DESCRIPTION OF EMBODIMENTS

For better clarity of the purpose, technical solution and advantages of the invention, the technical solution of the invention will be described clearly and completely in conjunction with the drawings in the embodiment of the invention. It is obvious that the described embodiment is a part of the embodiments of the invention, rather than all of the embodiments. Based on the embodiment of the invention, all other embodiments obtained by an ordinary person skilled in art without creative effort are within the claimed scope of the invention.

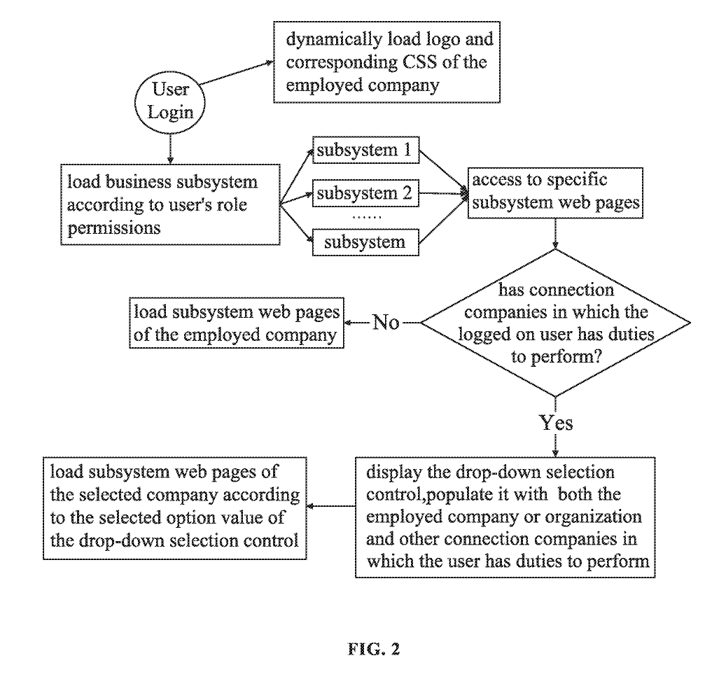

In one aspect of the embodiment of the invention, the embodiment provides a multiplexing, isolated and collaborative management information system and method, which may be implemented by a computer. FIG. 2 is a flow chart of a method for multiplexing, isolating and collaborating of a management information system according to the embodiment of the invention, When a user logs into the system, the system dynamically loads the LOGO and CSS styles of the company he/she belongs to according to the employed company information in the user information and loads each business subsystem according to the user's role permissions.

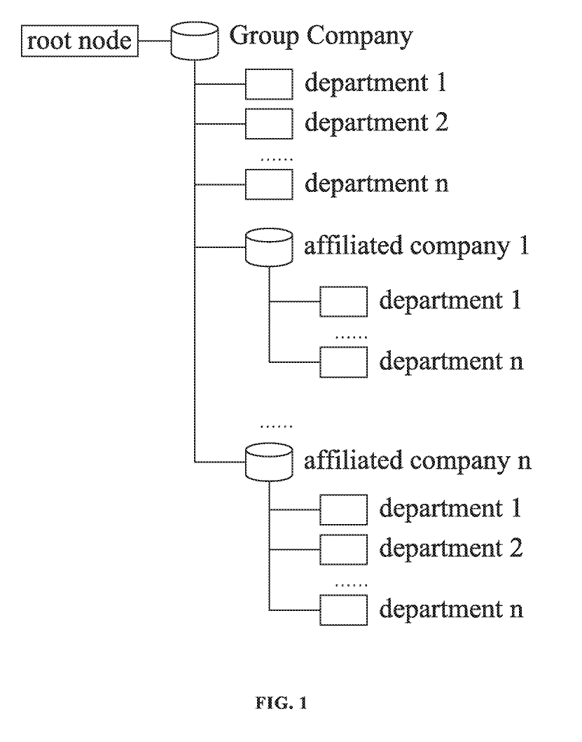

As shown in FIG. 1, it shows a schematic diagram of an organization tree in the method for multiplexing, isolating and collaborating of the management information system according to an embodiment of the invention. The system administrator or authorized user adds, modifies or deletes the organization tree node information through the company or department information interface, including the enterprise group, various departments of the group, various limited companies, and various departments of the company. The root node is the enterprise group, and the child nodes under the root node are the respective departments of the enterprise group or the companies of the enterprise group. Similar to the root node, each child node can also be regarded as the root node to derive an organization tree. the root node information of the organization tree may be pre-set in the database, or added by an administrator or authorized user through the interface provided by the system, and its subsidiaries and departments can be dynamically added. Child nodes are added to each node in the tree in the same way.

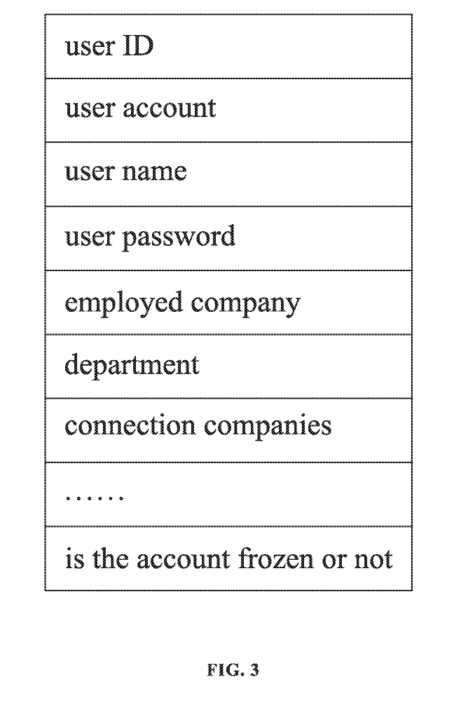

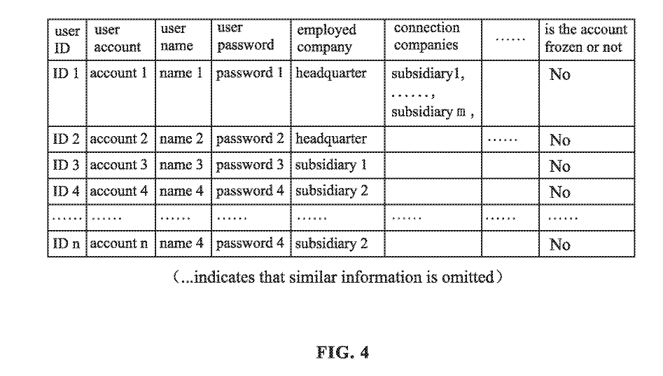

FIG. 3 is a field structure diagram of system user information in an embodiment of the invention, in which two fields are indispensable: the employed company and the connection companies. The former indicates the company where the user is emploeed, while the latter indicates that the user not only performs his duties in the former, but also performs certain duties in the connection companies. The system administrator and the administrators of subsidiaries dynamically add, modify or delete user information of the group company and the affiliated companies of the group company, respectively. The user information contains the employed company or organization characteristic information and the characteristic information of the connection companies or organizations;. It can dynamically add, modify or delete the employed company information and the connection company or organization information in each user information; The user information is temporarily stored in a random access memory (RAM) in an application server in the form of table as shown in FIG. 4, or persisted in the database server storage.

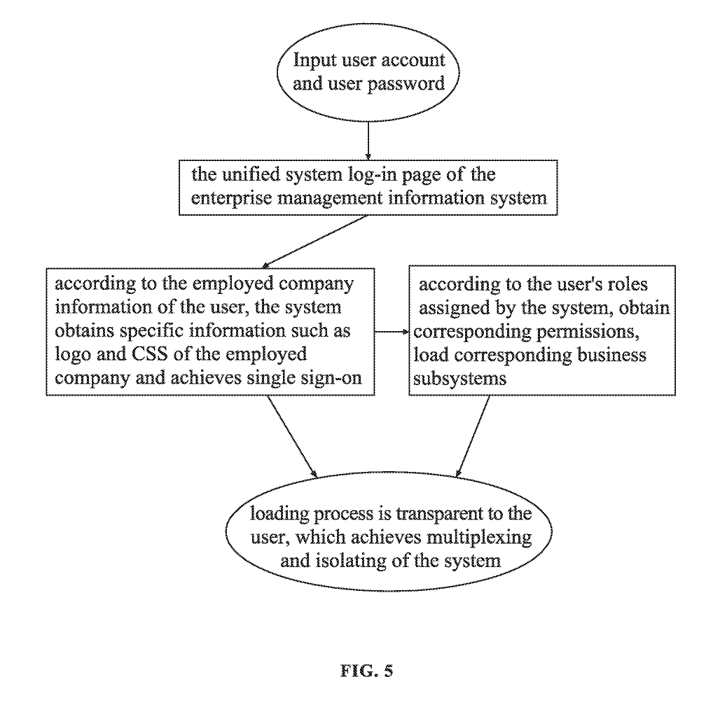

FIG. 5 shows the management information software system user login and system loading process. Users from different companies log in through a unified system log-in page. After login, according to the logged on user's employed company information, management information software system loads the corresponding group or its subsidiary LOGO, CSS files and other proprietary information respectively to achieve single sign-on. According to the user roles assigned by the system administrator, different users can obtain the corresponding permissions and the corresponding business subsystems of the system are loaded. This system login loading process is transparent to users, and the system and data are isolated and independent. At the same time, the whole system is jointly owned by each company, and each company user can access each subsystem within his/her permissions, so as to achieve the purpose of system multiplexing.

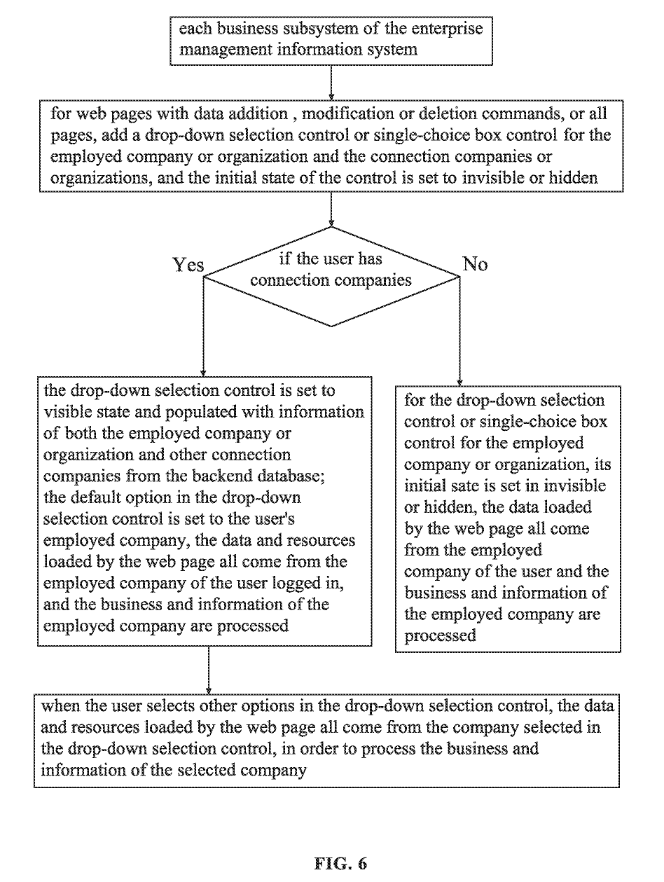

FIG. 6 shows collaboration of the management information software system, When accessing a specific subsystem web page, the system judges if the user has connection with other companies according to the connection company information in the user information. If the judgment is no, the initial state of the drop-down selection control ready to be populated with both the employed company or organization and other companies with which the user has connection is set to invisible or hidden. The web page only loads the data or resources from the employed company. The data newly modified or added in the web page belongs to the employed company of the user and the deleted data is removed from the employed company of the user. The data processed by the system is stored in a database and persisted to a hard disk of a computer or server. If the judgment is yes, the drop-down selection control is displayed and populated with both the employed company or organization and other companies with which the user has connection. The value for the initial selected option in the control is the employed company of the user, and the system loads the corresponding data and resources from the selected company or organization according to the value for the selected option in the drop-down selection control. The data modified or added in the web page belongs to the company or organization selected in the drop-down selection control, and the deleted data is removed from the company or organization selected in the drop-down selection control. The data processed by the system is stored in a database and persisted to a hard disk of a computer or server.

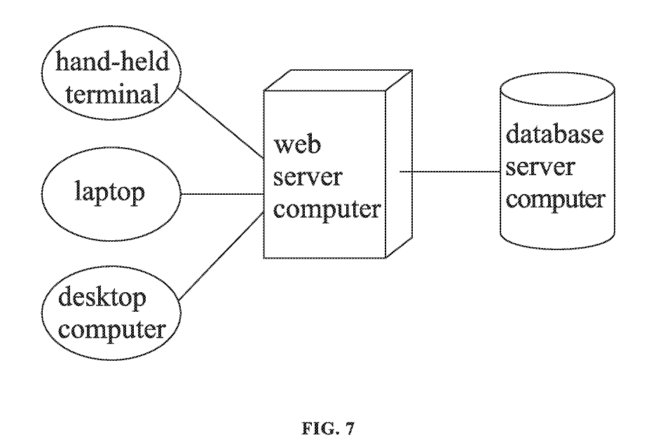

FIG. 7 is a schematic diagram of a hardware implementation for a multiplexing, isolated and collaborative management information system according to an embodiment of the invention. The computer hardware system such as the WEB server and the database server of the system may have relatively large differences due to different hardware configurations or performances such as a central processing unit CPU, a computer memory RAM, and a memory hard disk. The system configuration shown in FIG. 7 provides merely a web server computer and a database server computer, wherein the web server computer executes the instructions of the system according to an embodiment of the invention. The results from the execution of the web server computer are persisted in the storage of the database server. This is just a common way to configure hardware. You can also configure the web server and database server on the same computer or multiple computers. Users access the management information system installed in the web server computer through a web browser through a desktop computer, laptop computer or hand held terminal for data collection, modification or deletion. The processed data is persisted in the storage of a database server. Multiplexing, isolating and collaborating of the system are achieved.

As described above, the invention uses a management information system to manage the group company and all its independent companies, realizes the multiplexing, isolation, collaboration of the management information system, and realizes the system single sign-on of users between the the group company and its different independent companies. realizes the data unification of system between the the group company and its different affiliated companies, and eliminates the information isolated island.

The above described is merely preferable embodiments of the invention and is not to limit the scope of protection of the invention.

What is claimed is:

1. A multiplexing, isolated, collaborative management information system, comprising:
at least one or more non-volatile memories, and at least one or more processors, wherein the processor processing steps are as follows:
managing organization tree in the management information system, and dynamically adding, modifying or deleting group company department information, information on the affiliated company and affiliated company department under the group company;
dynamically adding, modifying or deleting the characteristic information of the employed company, organization or department information of the employed company or organization in the user information of the group company or the affiliated companies under the group company in which an employee belongs to; dynamically adding, modifying or deleting the characteristic information of the connection companies or organizations in which an employee has duties to perform in the user information;
dynamically loading the logo and cascading style sheets of the employed company or organization based on the employed company or organization information of a user; and
in each business subsystem, for each of the web page that has data adding, modifying or deleting operation command or other pages with collaboration requirements, adding a drop-down selection control or other single-choice box controls populated with information of both the employed company or organization and other connection companies to the pate, the data and resources loaded by the web page are all from the company or organization selected in the drop-down selection control or other single-choice box controls.

2. A method of multiplexing, isolating, collaborating of the management information system of claim 1 executed by computer, comprising:
1) managing organization tree in the management information system, and dynamically adding, modifying or deleting group company department information, affiliated companies or affiliated company department information under the group company;
2) dynamically adding, modifying or deleting the characteristic information of the employed company, organization or department information of the employed company or organization in the user information of the group company or the affiliated companies under the group company in which the employee belongs to; dynamically adding, modifying or deleting the characteristic information of the connection company or organization in the user information;
3) dynamically loading the logo and Cascading Style Sheets of the employed company or organization based on the employed company or organization information of the user; and
4) in each business subsystem, for each of the web page that has data adding, modifying, deleting operation command or other pages with collaboration requirements, adding a drop-down selection control or other single-choice box controls populated with both the employed company or organization information and information of other connection companies to the page, the data and resources loaded by the web page all are from the company or organization selected in the drop-down selection control or other single-choice box controls.

3. The method of claim 2, further comprising:
modifying, adding and deleting nodes in the organization tree; the root node is the group company, and the child node of the root node is each department of the group company or its affiliated limited company; each affiliated limited company node can also be regarded as the root node to derive an organizational tree;
presetting the root node information of the organization tree in the database, or adding the root node information by the administrator or authorized user through the interface provided by the system; dynamically adding its affiliated limited companies and departments, and adding child nodes to each node in the tree in the same way as above.

4. The method of claim 2, further comprising:
in each business subsystem of the management information system, for each of the web page that has the data adding or deleting operation command or other pages with collaboration requirements, adding a drop-down selection control or other single-choice box controls populated with both the employed company or organization information and information of other connection companies from user information to the page;
setting the initial state of the added drop-down selection control or single-choice box controls to invisible or hidden;
verifying the information of the employed company or organization and the connection company information of the logged in user by the system; and
if the connection company information is empty, keeping the drop-down selection control or single-choice box control in invisible or hidden state, or otherwise altering the state of the drop-down selection control or single-choice box control into visible or non-hidden state and populating it with both the employed company or organization information and information of other connection companies from user information from the backend database previously persisted during the user information management.

5. The method of claim 4, further comprising:
in each business subsystem, for the web page that has the drop-down selection control or single-choice box control for both the employed company or organization and the connection companies, if the drop-down selection control or single-choice box control is invisible or hidden, the data loaded by the web page all come from the employed company of the logged in user, and the newly modified or added data belongs to the employed company of the user, and the deleted data is removed from the employed company of the user;
if the drop-down selection control or single-choice box control is populated with the information on the group company and its affiliated companies from the backend. database, setting the default option of the drop-down selection control or single-choice box control to the employed company of the user, the data and resources loaded by the web page all come from the employed company of the logged in user, the modified or added data and resources belong to the employed company of the user, and the deleted data and resources all are removed from the employed company of the user;
once the user selects other options in the drop-down selection control or single-choice box control, the data and resources loaded by the web page all come from the company or organization selected in the drop-down selection control or single-choice box control, the newly modified or added data and resources belong to the company or organization selected in the drop-down selection control or single-choice box control, and the deleted data and resources all are removed from the company or organization selected in the drop-down selection control or single-choice box control.
